(19) United States
(12) Patent Application Publication
(10) Pub. No.: US 2024/0374045 A1
(43) Pub. Date: Nov. 14, 2024

(54) AIR MATTRESS SYSTEM

(71) Applicant: National Taiwan University of Science and Technology, Taipei (TW)

(72) Inventors: Chyi-Yeu Lin, Taipei (TW); Bahrudin, Taipei (TW)

(73) Assignee: National Taiwan University of Science and Technology, Taipei (TW)

(21) Appl. No.: 18/347,581

(22) Filed: Jul. 6, 2023

(30) Foreign Application Priority Data
May 12, 2023 (TW) 112117684

(51) Int. Cl. A47C 27/08

(52) U.S. Cl. CPC A47C 27/083; A47C 27/084; A61G 7/0005

(57) ABSTRACT

An air mattress system includes a mattress including main cells arranged in parallel between a head end and a tail end of the mattress. At least one of the main cells allows air pressure therein to be individually adjusted or adjusted together with air pressure of other main cells. Air pressure valves are connected to the main cells. A controller controls at least one of the air pressure valves to perform an inflation operation or a deflation operation. A human machine interface system provides health care items and receives a selective operation of a first target item among the health care items. The controller controls, according to the first target item, the air pressure valves to sequentially perform one of the deflation inflation operations on the main cells along a major axis between the head end and the tail end, and a health care operation is thus assisted.

### CROSS-REFERENCE TO RELATED APPLICATION

This application claims the priority benefit of Taiwan application serial no. 112117684, filed on May 12, 2023. The entirety of the above-mentioned patent applications is hereby incorporated by reference herein and made a part of this specification.

### BACKGROUND

### Technical Field

The disclosure relates to an air mattress, and in particular, relates to an air mattress system.

### Description of Related Art

The trend of global aging is irreversible. An increasing number of elderly people will become long-term bedridden patients at the end of their lives and thus need the care of caregivers. The most laborious caregiving actions include: changing diapers and putting on and taking off pants and tops because these actions all need to raise the patient's specific human body parts. However, carrying out these actions for a long time will cause occupational injury and bring physical burden to a caregiver.

### SUMMARY

In view of the above, an embodiment of the disclosure provides an air mattress system capable of providing assistance in health care operations.

In an embodiment of the disclosure, an air mattress system includes (but not limited to) a mattress, a plurality of air pressure valves, a controller, and a human machine interface system. The mattress includes a plurality of main cells. The main cells are arranged in parallel between a head end and a tail end of the mattress. At least one of the main cells is configured to allow air pressure therein to be individually adjusted or to be adjusted together with air pressure of other main cells. The air pressure valves are connected to the main cells and are configured to increase air pressure through an inflation operation or decrease air pressure through a deflation operation. The controller is coupled to the air pressure valves and controls at least one of the air pressure valves to perform the inflation operation or the deflation operation. The human machine interface system is coupled to the controller, provides a plurality of health care items, and receives a selective operation of a first target item among the health care items. The controller controls, according to the first target item, the air pressure valves to sequentially perform one of the deflation operation and the inflation operation on the main cells along a major axis between the head end and the tail end of the mattress.

To sum up, according to the air mattress system provided by the embodiments of the disclosure, the air pressure in the main cells is able to be adjusted sequentially for specific health care items, so that a caregiver is able to move in an accommodating space between the cells and a person lying down and then complete the corresponding health care operations.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block view of devices in an air mattress system according to an embodiment of the disclosure.

FIG. 2A is a schematic view illustrating an arrangement of cells according to an embodiment of the disclosure.

FIG. 2B is a schematic view illustrating an arrangement of cells according to an embodiment of the disclosure.

FIG. 2C is a schematic view illustrating an arrangement of cells according to an embodiment of the disclosure.

FIG. 2D is a schematic view illustrating an arrangement of cells according to an embodiment of the disclosure.

FIG. 3 is a schematic view illustrating an arrangement of devices according to an embodiment of the disclosure.

FIG. 4A to FIG. 4D are schematic views illustrating air pressure adjustment to take off/put on pants according to an embodiment of the disclosure.

FIG. 5A to FIG. 5D are schematic views illustrating air pressure adjustment to take off/put on a top according to an embodiment of the disclosure.

FIG. 6A to FIG. 6F are schematic views illustrating air pressure adjustment to take off/put on clothing according to an embodiment of the disclosure.

FIG. 7A and FIG. 7B are schematic views illustrating partial air deflation according to an embodiment of the disclosure.

FIG. 8A to FIG. 8F are schematic views illustrating air pressure adjustment to spread legs apart according to an embodiment of the disclosure.

### DESCRIPTION OF THE EMBODIMENTS

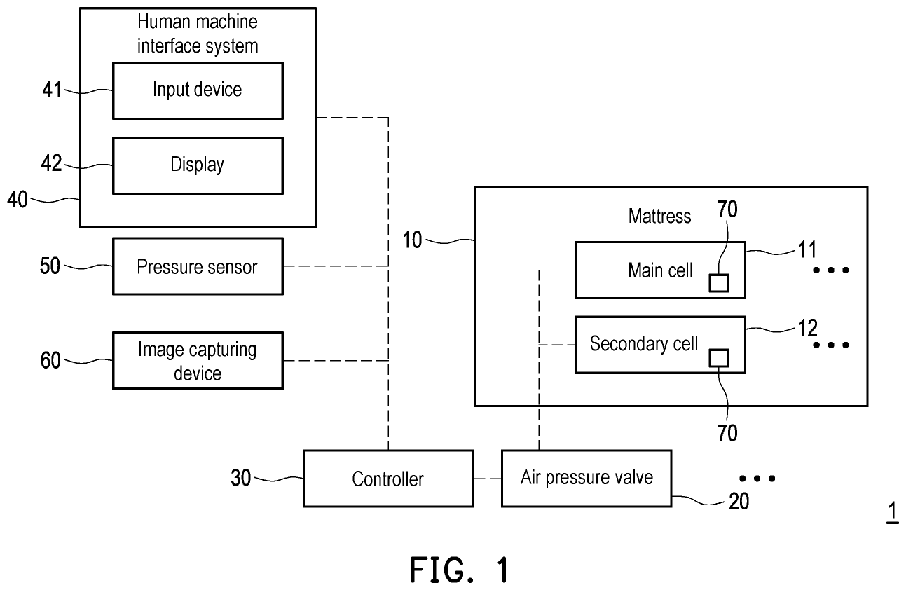

FIG. 1 is a block view of devices in an air mattress system 1 according to an embodiment of the disclosure. With reference to FIG. 1, the air mattress system 1 includes (but not limited to) a mattress 10, an air pressure valve 20, a controller 30, and a human machine interface system 40.

The mattress 10 may be rectangular, square, or other shapes. The mattress 10 includes a main (inflated) cell 11 and a secondary (inflated) cell 12. The main cell 11 and the secondary cell 12 may be disposed on a base.

In an embodiment, a plurality of main cells 11 are arranged in parallel between a head end and a tail end of the mattress 10. An imaginary major axis is formed between the head end and the tail end. The plurality of main cell 11 are arranged in parallel along the major axis.

In an embodiment, a plurality of secondary cells 12 are arranged in parallel between two opposite long sides of the mattress 10. An imaginary minor axis is formed between the two long sides. The plurality of secondary cells 12 are arranged in parallel along the minor axis.

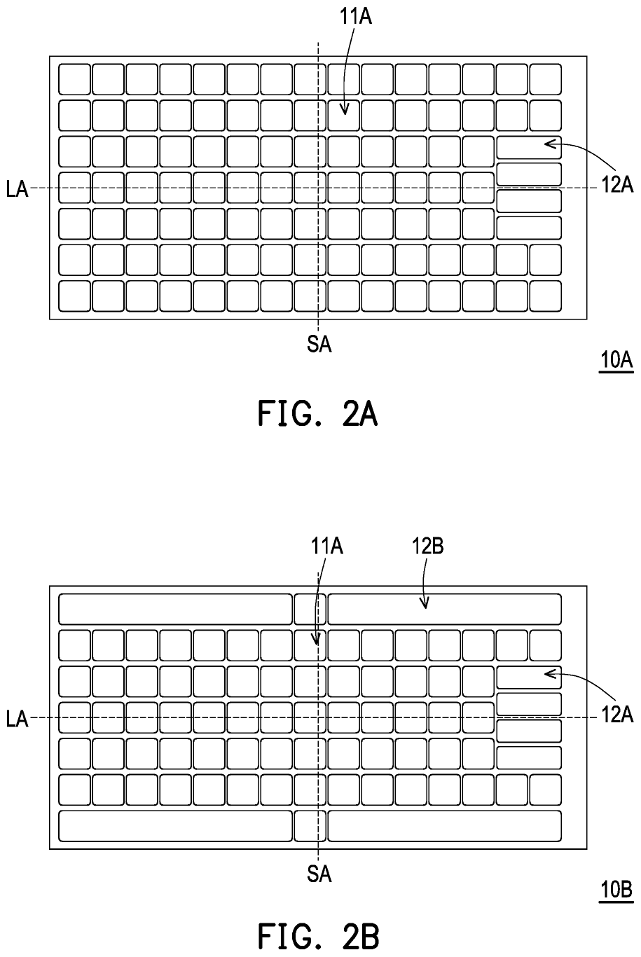

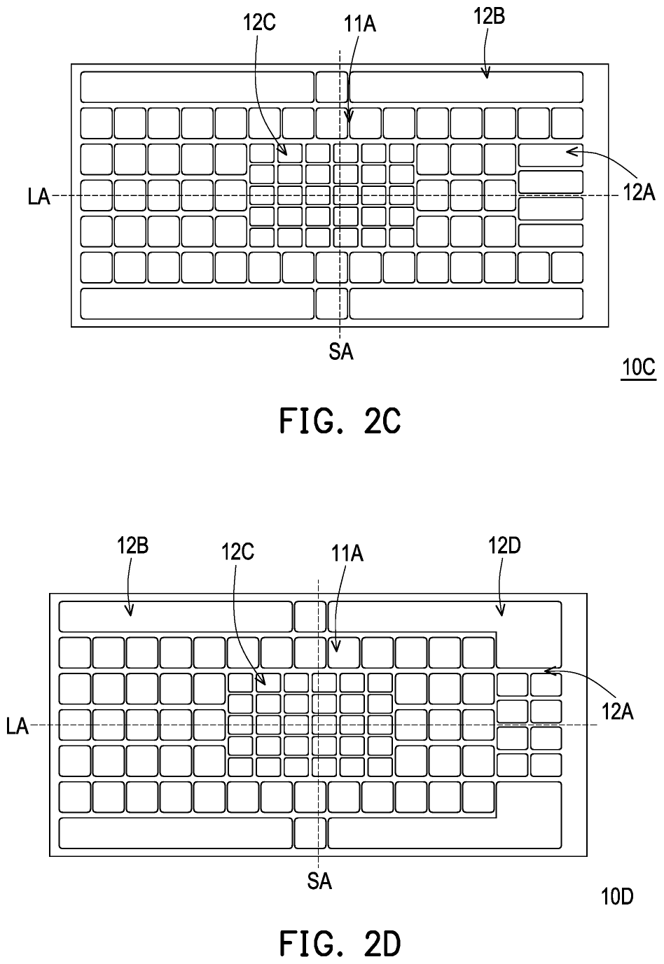

For instance, FIG. 2A is a schematic view illustrating an arrangement of cells according to an embodiment of the disclosure. With reference to FIG. 2A, the head end of a mattress 10A is located on the right side of the figure, and the tail end of the mattress 10A is located on the left side of the figure. Main cells 11A in a row in a vertical direction and the main cells 11A in adjacent rows on the left and right are arranged in parallel along a major axis LA (i.e., horizontal direction) of the mattress 10A. On the other hand, the plurality of secondary cells 12A are arranged in parallel along a minor axis SA (i.e., vertical direction) of the mattress 10A.

FIG. 2B is a schematic view illustrating an arrangement of cells according to an embodiment of the disclosure. With reference to FIG. 2B, compared to FIG. 2A, a mattress 10B further includes secondary cells 12B. The secondary cells 12B are adjacent to two opposite long sides of the mattress 10B. Besides, the plurality of secondary cells 12A and 12B are arranged in parallel along the minor axis SA (i.e., vertical direction) of the mattress 10B.

FIG. 2C is a schematic view illustrating an arrangement of cells according to an embodiment of the disclosure. With reference to FIG. 2C, compared to FIG. 2B, a mattress 10C further includes secondary cells 12C. The secondary cells 12C are located in the middle of the mattress 10C, and an area of each secondary cell 12C is less than that of a single main cell 11A. Besides, the plurality of secondary cells 12A, 12B, and 12C are arranged in parallel along the minor axis SA (i.e., vertical direction) of the mattress 10C.

FIG. 2D is a schematic view illustrating an arrangement of cells according to an embodiment of the disclosure. With reference to FIG. 2D, compared to FIG. 2C, a mattress 10D further includes secondary cells 12D. The secondary cells 12D extend from both sides of the head end of the mattress 10D to both sides of the middle of the mattress 10D. Besides, the plurality of secondary cells 12A to 12D are arranged in parallel along the minor axis SA (i.e., vertical direction) of the mattress 10D.

It should be noted that there may be other changes in the arrangements, shapes, and sizes of the main cells 11 and the secondary cells 12.

In an embodiment, at least one of the plurality of main cells 11 is configured to allow air pressure therein to be independently adjusted or to be adjusted together with air pressure of other main cells 11. That is, the air pressure in a specific one or more main cells 11 may be individually adjusted to inflate or deflate the individual or multiple main cells 11.

In an embodiment, at least one of the plurality of secondary cells 12 is configured to allow air pressure therein to be individually adjusted or to be adjusted together with air pressure of other secondary cells 12. That is, the air pressure in a specific one or more secondary cells 12 may be individually adjusted to inflate or deflate the individual or multiple secondary cells 12.

A plurality of air pressure valves 20 are connected to the plurality of main cells 11 and the plurality of secondary cells 12 and increase the air pressure in the main cells 11 and/or the secondary cells 12 through an inflation operation or decrease the air pressure in the main cells 11 and/or the secondary cells 12 through a deflation operation.

For instance, part of the air pressure valves 20 may be connected to a pump or to an air compressor. In the inflation operation, the air pressure valves 20 connected to the pump or the air compressor are opened to provide air to the main cells 11 and/or the secondary cells 12, and the air pressure in the main cells 11 and/or the secondary cells 12 is thus increased. When the air pressure valves 20 connected to the pump or the air compressor are closed, the supply of air to the main cells 11 and/or the secondary cells 12 stops. Further, part of the air pressure valves 20 may be connected to vents. In the deflation operation, the air pressure valves 20 connected to the pump or the air compressor and the air pressure valves 20 connected to the vents are opened, so that the air in the main cells 11 and/or the secondary cells 12 is discharged from the vents, and the air pressure in the main cells 11 and/or the secondary cells 12 is thus decreased.

In an embodiment, each of the air pressure valves 20 may be individually connected to a single main cell 11 or a single secondary cell 12, so as to individually perform the inflation operation or the deflation operation on the single main cell 11 or the single secondary cell 12.

In an embodiment, each of the air pressure valves 20 may be connected to plural main cells 11 or plural secondary cells 12, so as to perform the inflation operation or the deflation operation on the main cells 11 or the secondary cells 12 together.

The controller 30 is coupled to the air pressure valves 20 and the human machine interface system 40. The controller 30 may be an apparatus such as a desktop computer, a notebook computer, a smart phone, a tablet computer, a workstation, and a host computer or a processor (e.g., a central processing unit (CPU), a microcontroller, a programmable controller, an application-specific integrated circuit (ASIC), a chip, or other similar devices or a combination thereof). In an embodiment, the controller 30 is configured to control the operation of the electronic components or electronic devices in the air mattress system 1.

The human machine interface system 40 includes an input device 41 and a display 42.

The input device 41 may be a touch panel, a button, a mouse, a microphone or an image sensor. In an embodiment, the input device 41 is configured to receive a user instruction. For instance, the touch panel receives a click or slide operation, the button receives a press operation, the mouse clicks or moves, the microphone receives a voice command, or the image sensor captures a gesture image.

The display 42 may be an LCD display, a LED display, or an OLED display. In an embodiment, the display 42 is configured to display an image or a user interface.

In an embodiment, the air mattress system 1 further includes a pressure sensor 50. The pressure sensor 50 is coupled to the controller 30. The pressure sensor 50 may be a piezoresistive pressure sensor, a strain gauge pressure sensor, a piezoelectric pressure sensor, or other forms of pressure sensors. In an embodiment, the pressure sensor 50 is disposed in at least one of the plurality of main cells 11 or at least one of the plurality of secondary cells 12 and is configured to detect an air pressure value. That is, each main cell 11/secondary cell 12 or a group of main cells 11/secondary cells 12 is provided with one pressure sensor 50.

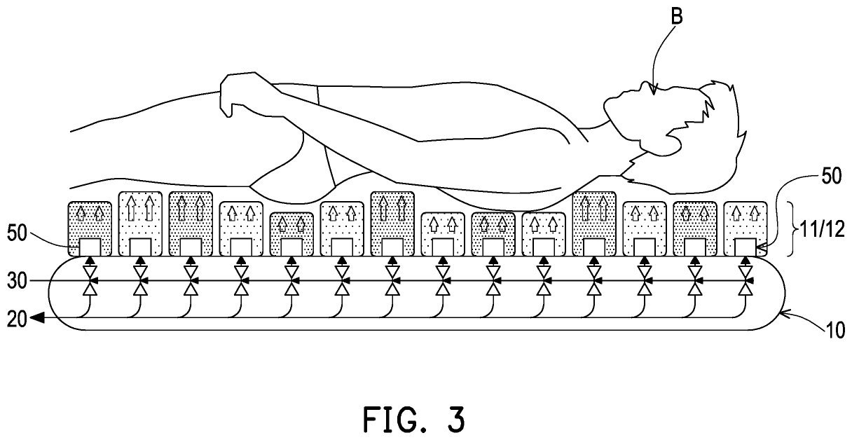

For instance, FIG. 3 is a schematic view illustrating an arrangement of devices according to an embodiment of the disclosure. With reference to FIG. 3, the pressure sensors 50 are disposed in the main cells 11 or the secondary cells 12. The controller 30 may, according to the air pressure value obtained by the pressure sensor 50, determine positions of multiple human body parts of a human body B on the cells and an overall weight distribution and may also be configured to adjust the air pressure valves 20 to determine how much pressure the air compressor or pump must deliver to each main cell 11/secondary cell 12.

In some embodiments, the air mattress system 1 further includes an image capturing device 60. The image capturing device 60 is coupled to the controller 30. The image capturing device 60 may be a device for capturing images such as a camera or a video camera, and the image capturing device 60 may include an image sensor (e.g., a charge coupled device (CCD), a complementary-metal-oxide-semiconductor (CMOS), etc.), an optical lens, an image control circuit, and other devices. In this embodiment, lens specifications of the image capturing device 60 (e.g., imaging aperture, magnification, focal length, imaging viewing angle, image sensor size, etc.) are different, and the number thereof may be adjusted according to actual needs. In an embodiment, one or a plurality of image capturing devices 60 may be fixed on the side or top of the mattress 10 to take pictures of the main cells 11, the secondary cells 12, and/or the human body thereon and generate an image accordingly.

In an embodiment, the air mattress system 1 further includes a distance sensor 70. The distance sensor 70 is coupled to the controller 30. The distance sensor 70 may be a proximity sensor, a ToF sensor, an ultrasonic transceiver, or a radar. In an embodiment, one or a plurality of distance sensors 70 may be fixed on the side of the mattress 10 or on the side adjacent to the mattress 10, so as to detect the body of a caregiver and generate distance information accordingly.

In the following paragraphs, a method or a process described in the embodiments of the disclosure is to be described together with the various devices and components in the air mattress system 1. The steps of the method may be adjusted according to actual implementation and are not limited by the disclosure.

In an embodiment, the display 42 of the human machine interface system 40 provides a plurality of health care items. For instance, the user interface displays options or input fields of the health care items. The health care items are items corresponding to care actions, such as putting on/taking off a top/pants, changing a diaper, and wiping and washing the patient's buttocks or genital area. However, the content of health care items may still be changed according to actual needs.

The input device 41 of the human machine interface system 40 receives a selective operation of a first target item among the health care items. For instance, a touch screen detects a click operation of the first target item, the microphone receives a voice command of the first target item, or the image sensor captures a gesture of the first target item.

The controller 30 may control, according to the first target item, the plurality of air pressure valves 20 to sequentially perform one of the deflation operation and the inflation operation on the plurality of main cells 11 along the major axis between the head end and the tail end of the mattress 10. “Sequentially” means that after the air pressure in one of the adjacent main cells 11 is decreased (i.e., being applied by the deflation operation), the air pressure in other adjacent main cell 11 is then continuously decreased, and while the air pressure of this cell is being decreased, the cell whose air pressure has been decreased is subjected to air-pressure increasing (i.e., being applied by the inflation operation) instead. To put it simply, each main cell 11 sequentially undergoes the air-pressure decreasing action and air-pressure increasing action, and the air-pressure decreasing occurs in the connected adjacent cell and appears to be carried out sequentially in one direction. When the next cell also completes or nearly completes the air-pressure decreasing, the previous cell that has been subjected to air-pressure decreasing is then to be inflated and subjected to the air-pressure increasing action. For instance, when the air-pressure decreasing action performed on the next cell reaches half, air-pressure increasing is performed on the previous cell which has been subjected to air-pressure decreasing. Alternatively, the interval time between air-pressure increasing and air-pressure decreasing of two connected cells is related to the deflation and/or inflation speed, for example, an interval of 1 or 1.5 seconds. However, the interval time between air-pressure increasing and air-pressure decreasing of two connected cells may still be adjusted according to needs. It is worth noting that when the air pressure of some main cells 11 is decreased, the height of these main cells 11 drops and forms an accommodating space together with a person lying down (i.e., the person lying down does not directly press down on the main cells 11). In this way, the hands of the caregiver or other tools may easily reach into the accommodating space without being under the pressure of the weight of the human body, and then perform related care actions.

In an embodiment, the plurality of main cells 11 include a first cell group and a second cell group. The first cell group and the second cell group each includes at least one main cell 11. The first cell group is adjacent to the second cell group. The at least one main cell 11 of the first cell group and the at least one main cell 11 of the second cell group are arranged in parallel, and positions of the first cell group and the second cell group on the major axis are different.

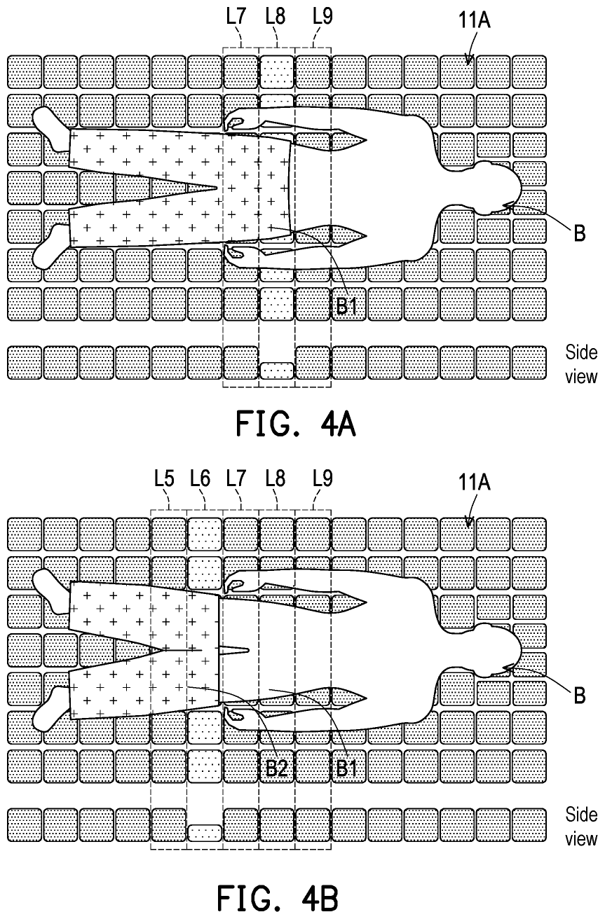

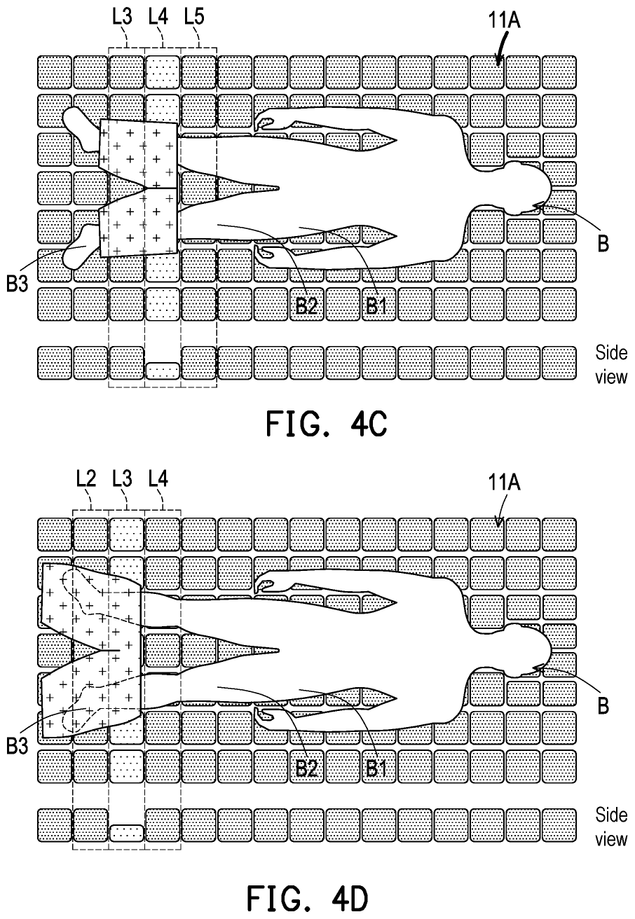

For instance, FIG. 4A to FIG. 4D are schematic views illustrating air pressure adjustment to take off/put on pants according to an embodiment of the disclosure. With reference to FIG. 4A, cell groups L7, L8, and L9 each includes a plurality of main cells 11A. The cell groups L7, L8, and L9 are parallel to one another in the horizontal direction (corresponding to the major axis of the mattress 10) of the figure. The cell group L7 is located to the left of the cell group L8 on the major axis, and the cell group L8 is located to the left of the cell group L9 on the major axis.

For the first target item, the controller 30 performs the deflation operation on the first cell group through one or more air pressure valves 20. Taking FIG. 4A as an example, the main cells 11A of the cell group L8 are deflated. In response to the deflation operation performed on the first cell group, the controller 30 may perform the inflation operation on the second cell group through one or more air pressure valves 20. Taking FIG. 4A as an example, when the deflation operation is performed on the cell group L8, the inflation operation is performed on the cell groups L7 and L9. At this time, the cell group L7 to 19 and a human body part B1 (e.g., the waist or buttocks) of the human body B form an accommodating space.

In an embodiment, the first target item is to take off pants, and the controller 30 may control one or more air pressure valves 20 to sequentially perform the deflation operation on the main cells 11 under the buttocks, legs, and feet of the human body in a direction of the tail end of the mattress 10. That is, the deflation starts from the main cells 11 or the cell group under the buttocks corresponding to the waistband and proceeds to the main cells 11 or the cell group under the legs corresponding to the pants and then to the main cells 11 or the cell group under the feet corresponding to the pant legs. Further, in response to the hand (of the caregiver) moving away from one of the buttocks, the legs, and the feet, the controller 30 may perform the inflation operation on the main cells 11 under the position where the hand moves away through one or more air pressure valves 20.

Taking FIG. 4A as an example, first, the air pressure of the cell group 18 under the human body part B1 (e.g., waist or buttocks) is decreased, so that the hand of the caregiver may go deep under the human body part B1 and then grasp the waistband. The air pressure of the other cell groups (e.g., the cell groups L7 and L9) has not been decreased, so these cell groups may support the human body B.

Sequentially, the air pressure of the cell group L7 is decreased, and the air pressure of the cell group L8 is increased, so that the waistband may be further pulled down. With reference to FIG. 4B, next, the air pressure of a cell group L6 under a human body part B2 (e.g., legs) is decreased and the hand moves away from the cell group L7, so that the air pressure in the cell group L7 is increased, and the waistband may thus be further pulled down to the human body part B2. After the air pressure of a cell group L5 is decreased and the air pressure of the cell group L6 is increased, with reference to FIG. 4C, next, the hand moves away from the cell group L5, so that the air pressure of the cell group L5 may be increased and the air pressure of a cell group L4 is decreased, so the waistband may be further pulled down to the position above the cell group L4.

With reference to FIG. 4D, next, the air pressure of a cell group L3 is decreased and the hand moves away from the cell group L4, so that the air pressure in the cell group L4 is increased, and the waistband may be further pulled down to the position above the cell group L3 (corresponding to a human body part B3 (e.g., feet)). At this time, the caregiver can further separate the pants from the human body B1 to complete the action of taking off the pants.

It should be noted that, in this context, the time interval between air pressure decreasing and air pressure increasing of the adjacent cell group may be related to inflation and deflation speeds, lifting heights and/or specific times.

In an embodiment, the first target item is to put on pants, and the controller 30 controls one or more air pressure valves 20 to sequentially perform the deflation operation on the main cells 11 under the feet, the legs, and the buttocks of the human body in a direction of the head end of the mattress 10. In other words, in the reverse order of taking off the pants, the deflation starts from the main cells 11 or the cell group under the feet and then proceeds to the main cells 11 or the cell group under the legs and then to the main cells 11 or the cell group under the waist or the buttocks. Further, in response to the hand (of the caregiver) moving away from one of the feet, the legs, and the buttocks, the controller 30 may perform the inflation operation on the main cells 11 under the position where the hand moves away through one or more air pressure valves 20.

Taking FIG. 4A to FIG. 4D as an example, with reference to FIG. 4D, first, the air pressure of the cell group L3 under the human body part B3 is decreased, so that the caregiver can pull the waistband to the human body part B3. The air pressure of the other cell groups (e.g., cell groups L2 and L3) has not been decreased, so these cell groups may support the human body B.

With reference to FIG. 4C, next, the air pressure of the cell group L4 is decreased and the hand moves away from the cell group L3, so that the air pressure in the cell group L3 is increased, and the waistband may thus be further pulled up towards the human body part B2. Sequentially, the air pressure of the cell group L5 is decreased, and the air pressure of the cell group L6 is increased, so that the waistband may be further pulled up. With reference to FIG. 4C, next, the hand moves away from the cell group L5, so that the air pressure of the cell group L5 may be increased and the air pressure of the cell group L6 is decreased, so the waistband may be further pulled up to the human body part B2.

Sequentially, the air pressure of the cell group L7 is decreased, and the air pressure of the cell group L6 is increased, so that the waistband may be further pulled up. With reference to FIG. 4A, next, the air pressure of the cell group L8 is decreased and the hand moves away from the cell group L7, so that the air pressure in the cell group L7 is increased, and the waistband may thus return to the human body part B1. At this time, the action of putting on the pants is completed.

In an embodiment, the first target item is to take off a top, and the controller 30 may control one or more air pressure valves 20 to sequentially perform the deflation operation on the main cells 11 under the buttocks or waist, the back, and the head of the human body in the direction of the head end of the mattress 10. In other words, the deflation starts from the main cells 11 or the cell group under the buttocks or waist and then proceeds to the main cells 11 or the cell group under the back and then to the main cells 11 or the cell group under the head. Further, in response to the hand (of the caregiver) moving away from one of the buttocks, the waist, the back, and the head, the controller 30 may perform the inflation operation on the main cells 11 under the position where the hand moves away through one or more air pressure valves 20.

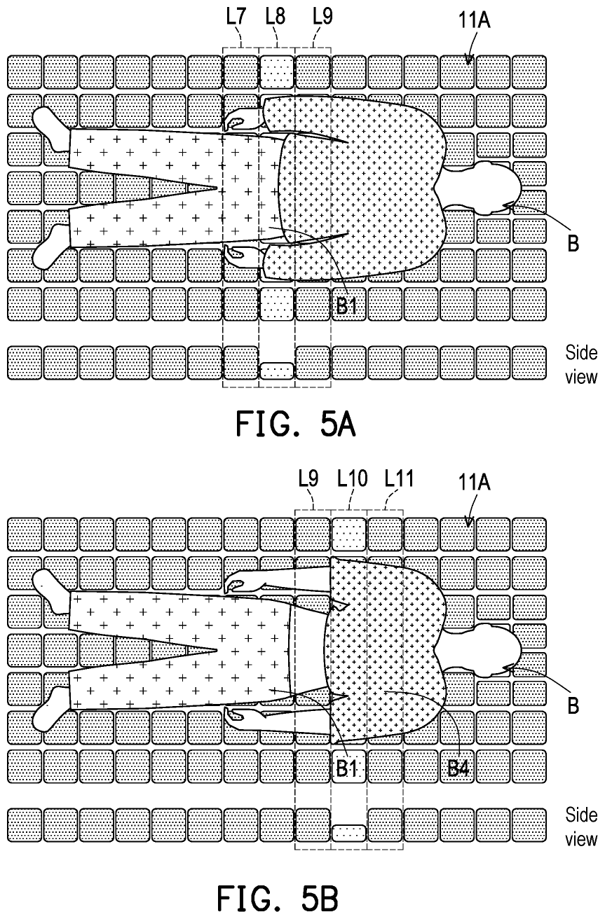

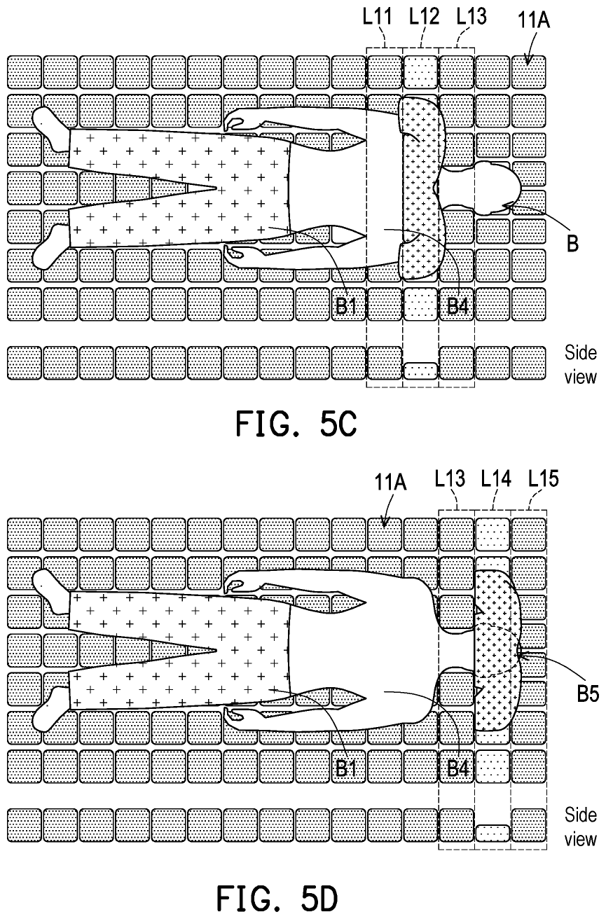

For instance, FIG. 5A to FIG. 5D are schematic views illustrating air pressure adjustment to take off/put on a top according to an embodiment of the disclosure. With reference to FIG. 5A, first, the air pressure of the cell group L8 under the human body part B1 (e.g., waist or buttocks) is decreased, so that the hand of the caregiver may go deep under the human body part B1 and then grasp the hem. The air pressure of the other cell groups (e.g., the cell groups L7 and L9) has not been decreased, so these cell groups may support the human body B.

Sequentially, the air pressure of the cell group L9 is decreased, and the air pressure of the cell group L8 is increased, so that the hem may be further pulled up. With reference to FIG. 5B, next, the air pressure of a cell group L10 under a human body part B4 (e.g., back) is decreased and the hand moves away from the cell group L9, so that the air pressure in the cell group L9 is increased, and the hem may thus be further pulled up to the human body part B4. Sequentially, the air pressure of the cell group L10 is decreased, and the air pressure of the cell group L9 is increased, so that the hem may be further pulled up. Next, the air pressure of a cell group L11 is decreased, and the air pressure of the cell group L10 is increased. With reference to FIG. 5C, next, the hand moves away from the cell group L11, so that the air pressure of the cell group L11 may be increased and the air pressure of a cell group L12 is decreased, so the waistband may be further pulled down to the position above the cell group L12.

Sequentially, the air pressure of a cell group L13 is decreased, and the air pressure of the cell group L12 is increased, so that the hem may be further pulled up. With reference to FIG. 5D, next, the air pressure of a cell group L14 is decreased, so that the hem may be further pulled down to the position above the cell group L14 (corresponding to a human body part B5 (e.g., head)). At this time, the caregiver can further separate the top from the human body part B5 to complete the action of taking off the top.

In an embodiment, the first target item is to put on a top, and the controller 30 may control one or more air pressure valves 20 to sequentially perform the deflation operation on the main cells 11 under the head, the back, and the buttocks or waist of the human body in the direction of the tail end of the mattress 10. In other words, the deflation starts from the main cells 11 or the cell group under the head and then proceeds to the main cells 11 or the cell group under the back and then to the main cells 11 or the cell group under the buttocks or waist. Further, in response to the hand (of the caregiver) moving away from one of the head, the back, the waist, and the buttocks, the controller 30 may perform the inflation operation on the main cells 11 under the position where the hand moves away through one or more air pressure valves 20.

Taking FIG. 5A to FIG. 5D as an example, with reference to FIG. 5D, first, the air pressure of the cell group L14 under the human body part B5 is decreased, so that the caregiver can pull the top to the human body part B5. The air pressure of the other cell groups (e.g., the cell groups L13 and L15) has not been decreased, so these cell groups may support the human body parts B1. B4, and B5.

Sequentially, the air pressure of the cell group L13 is decreased, and the air pressure of the cell group L14 is increased, so that the hem of the top may be further pulled down. With reference to FIG. 5C, next, the air pressure of the cell group L12 is decreased and the hand moves away from the cell group L13, so that the air pressure in the cell group L13 is increased, and the hem may thus be further pulled down towards the human body part B1. Sequentially, the air pressure of the cell group L13 is decreased, and the air pressure of the cell group L14 is increased, so that the hem may be further pulled down. Next, the air pressure of the cell group L12 is decreased, and the air pressure of the cell group L13 is increased. Next, the air pressure of the cell group L11 is decreased, and the air pressure of the cell group L12 is increased. With reference to FIG. 5B, next, the hand moves away from the cell group L11, so that the air pressure of the cell group L11 may be increased and the air pressure of the cell group L10 is decreased, so the hem may be further pulled down to the group L10.

Sequentially, the air pressure of the cell group 19 is decreased, and the air pressure of the cell group L10 is increased, so that the hem may be further pulled down. With reference to FIG. 5A, next, the air pressure of the cell group L8 is decreased and the hand moves away from the cell group L9, so that the air pressure in the cell group 19 is increased, and the hem may thus return to the human body part B1. At this time, the action of putting on the top is completed.

In an embodiment, the first target item is to take off clothing, and the controller 30 may control one or more air pressure valves 20 to sequentially perform the deflation operation on the main cells 11 under the feet, the legs, the buttocks, the waist, the back, and the head of the human body in the direction of the head end of the mattress 10. In other words, the deflation starts from the main cells 11 or the cell group under the feet and then proceeds to the main cells 11 or the cell group under the legs, the buttocks, the waist, the back, and the head. Further, in response to the hand (of the caregiver) moving away from one of the feet, the legs, the buttocks, the waist, the back, and the head, the controller 30 may perform the inflation operation on the main cells 11 under the position where the hand moves away through one or more air pressure valves 20.

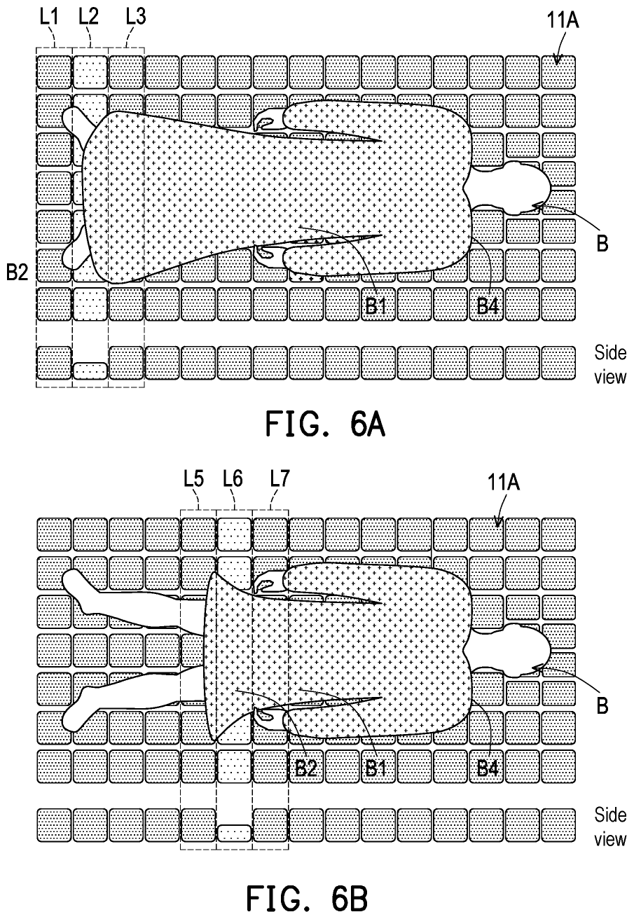

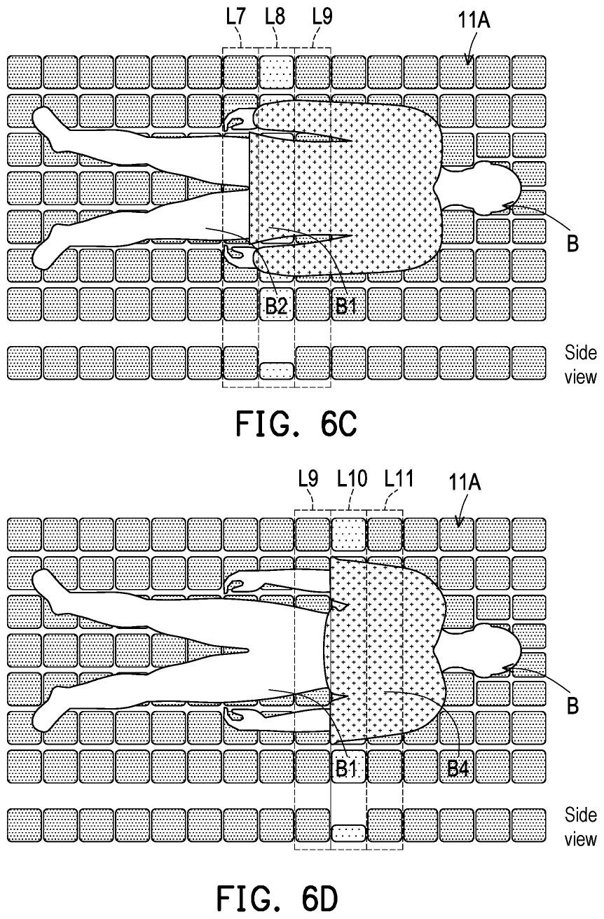

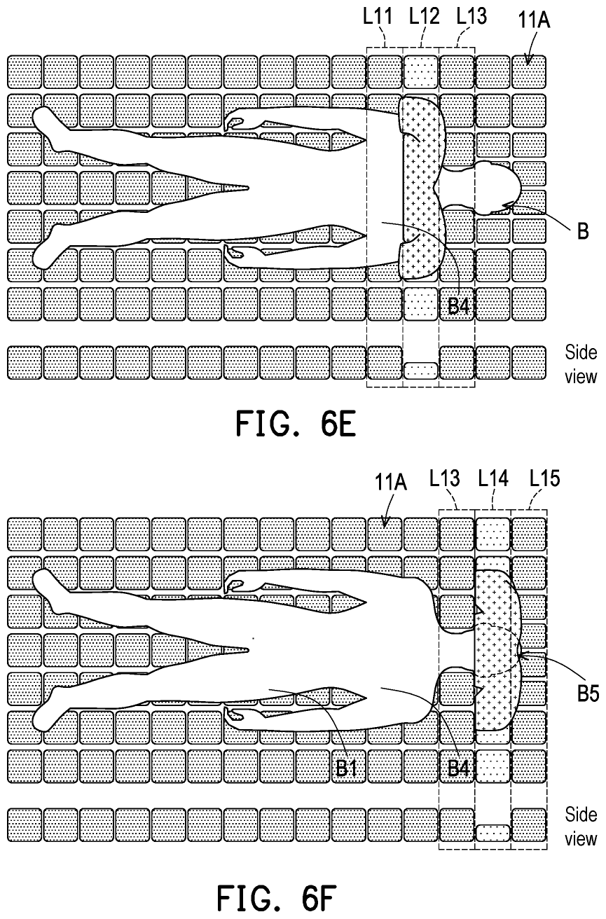

For instance, FIG. 6A to FIG. 6F are schematic views illustrating air pressure adjustment to take off/put on clothing according to an embodiment of the disclosure. With reference to FIG. 6A, first, the air pressure of the cell group L3 under the human body part B3 is decreased, so that the caregiver can grasp the hem of the clothing. The air pressure of the other cell groups (e.g., the cell groups L2 and L3) has not been decreased, so these cell groups may support the human body B.

Next, the air pressure of the cell group L4 is decreased and the hand moves away from the cell group L3, so that the air pressure in the cell group L3 is increased, and the waistband may thus be further pulled up towards the human body part B2. Sequentially, the air pressure of the cell group L5 is decreased, and the air pressure of the cell group 16 is increased, so that the waistband may be further pulled up. With reference to FIG. 6B, next, the hand moves away from the cell group L5, so that the air pressure of the cell group L5 may be increased and the air pressure of the cell group L6 is decreased, so the hem may be further pulled up to the human body part B2.

Sequentially, the air pressure of the cell group L7 is decreased, and the air pressure of the cell group L6 is increased, so that the hem may be further pulled up. With reference to FIG. 6C, next, the air pressure of the cell group L8 is decreased and the hand moves away from the cell group L7, so that the air pressure in the cell group L7 is increased, and the hem may thus return to the human body part B1.

Sequentially, the air pressure of the cell group 19 is decreased, and the air pressure of the cell group 18 is increased, so that the hem may be further pulled up. With reference to FIG. 6D, the air pressure of the cell group L10 under the human body part B4 is decreased and the hand moves away from the cell group L9, so that the air pressure in the cell group L9 is increased, and the hem may thus be pulled up to the position under the human body part B4.

Sequentially, the air pressure of the cell group L11 is decreased, and the air pressure of the cell group L10 is increased, so that the hem may be further pulled up. With reference to FIG. 6E, next, the hand moves away from the cell group L11, so that the air pressure of the cell group L11 may be increased and the air pressure of the cell group L12 is decreased, so the hem may be further pulled to the position above the cell group L12.

Sequentially, the air pressure of the cell group L13 is decreased, and the air pressure of the cell group L12 is increased, so that the hem may be further pulled up. With reference to FIG. 6F, next, the air pressure of the cell group L14 is decreased, so that the hem may be further pulled down to the position above the cell group L14 (corresponding to the human body part B5 (e.g., head)). At this time, the caregiver can further separate the clothing from the human body part B5 to complete the action of taking off the clothing.

In an embodiment, the first target item is to put on clothing, and the controller 30 may control one or more air pressure valves 20 to sequentially perform the deflation operation on the main cells 11 under the head, the back, the waist, the buttocks, the legs, and the feet of the human body in the direction of the tail end of the mattress 10. In other words, the deflation starts from the main cells 11 or the cell group under the head and then proceeds to the main cells 11 or the cell group under the back, the waist, the buttocks, the legs, and the feet. Further, in response to the hand (of the caregiver) moving away from one of the head, the back, the waist, the buttocks, the legs, and the feet, the controller 30 may perform the inflation operation on the main cells 11 under the position where the hand moves away through one or more air pressure valves 20.

Taking FIG. 6A to FIG. 6F as an example, with reference to FIG. 6F, first, the air pressure of the cell group L14 under the human body part B5 is decreased, so that the caregiver can pull the clothing to the human body part B5. The air pressure of the other cell groups (e.g., the cell groups L13 and L15) has not been decreased, so these cell groups may support the human body parts B1, B4, and B5.

Sequentially, the air pressure of the cell group L13 is decreased, and the air pressure of the cell group L14 is increased, so that the hem of the clothing may be further pulled down. With reference to FIG. 6E, next, the air pressure of the cell group L12 is decreased and the hand moves away from the cell group L13, so that the air pressure in the cell group L13 is increased, and the hem may thus be further pulled down towards the human body part B1. Sequentially, the air pressure of the cell group L13 is decreased, and the air pressure of the cell group L14 is increased, so that the hem may be further pulled down. Next, the air pressure of the cell group L12 is decreased, and the air pressure of the cell group L13 is increased. Next, the air pressure of the cell group L11 is decreased, and the air pressure of the cell group L12 is increased. With reference to FIG. 6D, next, the hand moves away from the cell group L11, so that the air pressure of the cell group L11 may be increased and the air pressure of the cell group L10 is decreased, so the hem may be further pulled down to the group L10.

Sequentially, the air pressure of the cell group 19 is decreased, and the air pressure of the cell group L10 is increased, so that the hem may be further pulled down. With reference to FIG. 6C, next, the air pressure of the cell group L8 is decreased and the hand moves away from the cell group L9, so that the air pressure in the cell group L9 is increased, and the hem may thus return to the human body part B1.

Sequentially, the air pressure of the cell group L7 is decreased, and the air pressure of the cell group L8 is increased, so that the hem may be further pulled down. With reference to FIG. 6B, next, the hand moves away from the cell group L7, so that the air pressure of the cell group L7 may be increased and the air pressure of the cell group L6 is decreased, so the hem may be further pulled down to the position above the cell group L6.

Sequentially, the air pressure of the cell group L5 is decreased, and the air pressure of the cell group L6 is increased, so that the hem may be further pulled down. Next, the air pressure of the cell group L4 is decreased, and the air pressure of the cell group L5 is increased. With reference to FIG. 4D, next, the air pressure of the cell group L3 is decreased and the air pressure of the cell group L4 is increased, so that the waistband may be further pulled down to the position above the cell group L3 (corresponding to the human body part B3 (e.g., feet)). At this time, the action of putting on the clothing is completed.

In an embodiment, the input device 41 of the human machine interface system 40 receives a selective operation of a second target item among the health care items. For instance, the touch screen detects a click operation of the second target item, the microphone receives a voice command of the second target item, or the image sensor captures a gesture of the second target item.

The controller 30 may control, according to the second target item, one or more air pressure valves 20 to perform one of the deflation operation and the inflation operation on the plurality of secondary cells 12. Similarly, it is worth noting that when the air pressure of some secondary cells 12 is decreased, the height of these secondary cells 12 drops and forms an accommodating space together with the person lying down (i.e., the person lying down does not directly press down on the secondary cells 12). In this way, the hands of the caregiver or other tools may easily reach deep into the accommodating space and then perform related care actions.

In an embodiment, for the second target item, the controller 30 may perform the deflation operation on part or all of the secondary cells 12 through plural air pressure valves 20. The second target item may be to change a diaper and wipe and wash the buttocks or genital area of a patient.

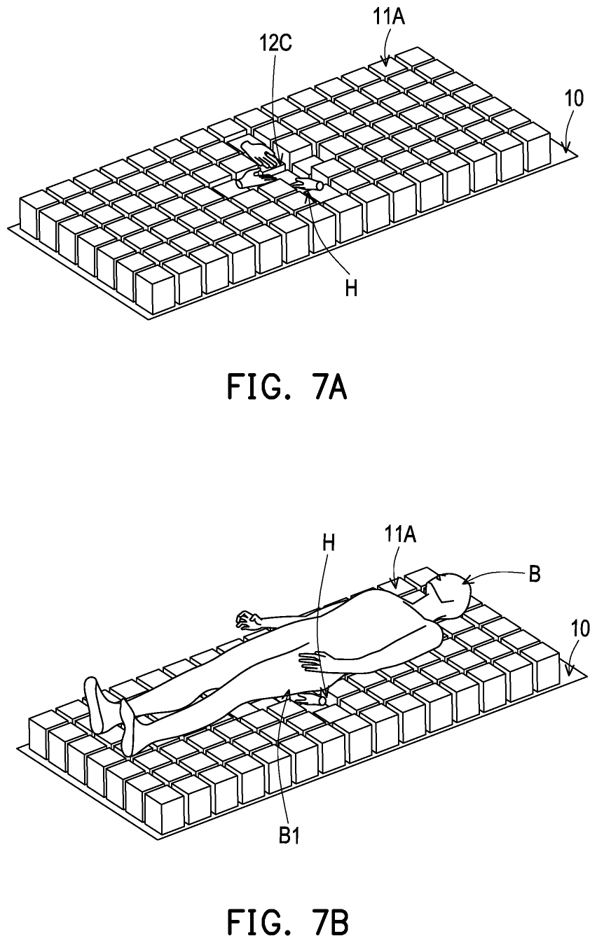

For instance, FIG. 7A and FIG. 7B are schematic views illustrating partial air deflation according to an embodiment of the disclosure. With reference to FIG. 7A, the air pressure of the secondary cells 12C disposed in the middle of the mattress 10 is decreased, so that a hand H may reach in deeply. With reference to FIG. 7B, when the human body B lies on the main cells 11A, these main cells 11A may support the weight of the human body B. In addition, the hand H may clean the human body part B1 or put on and take off clothes on the human body part B1.

In an embodiment, in response to the deflation operation performed on the secondary cells 12 under the intergluteal cleft of the human body, the controller 30 may perform the inflation operation on the secondary cells 12 under the buttocks and between the legs of the human body and performs the deflation operation on the secondary cells outside the legs through one or more air pressure valves.

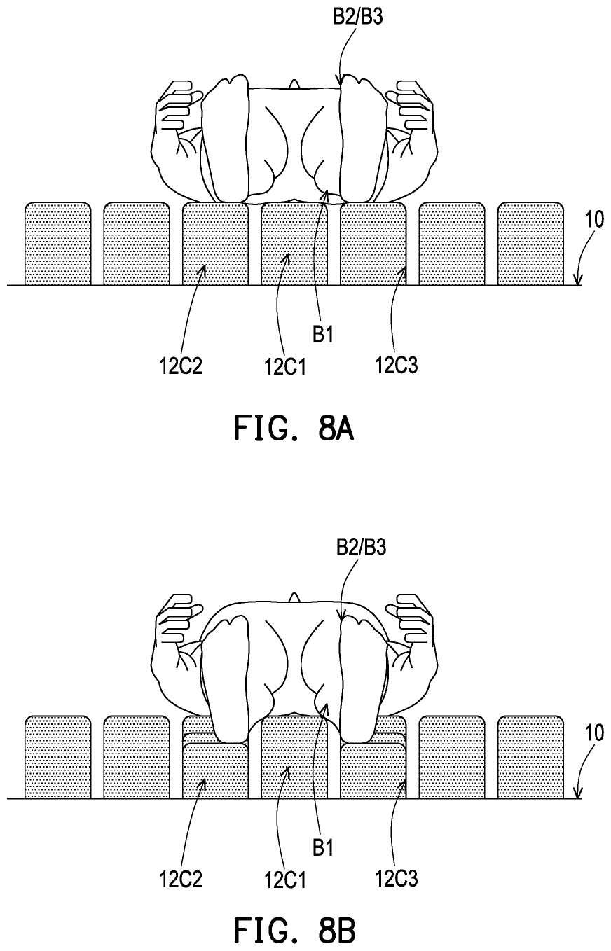

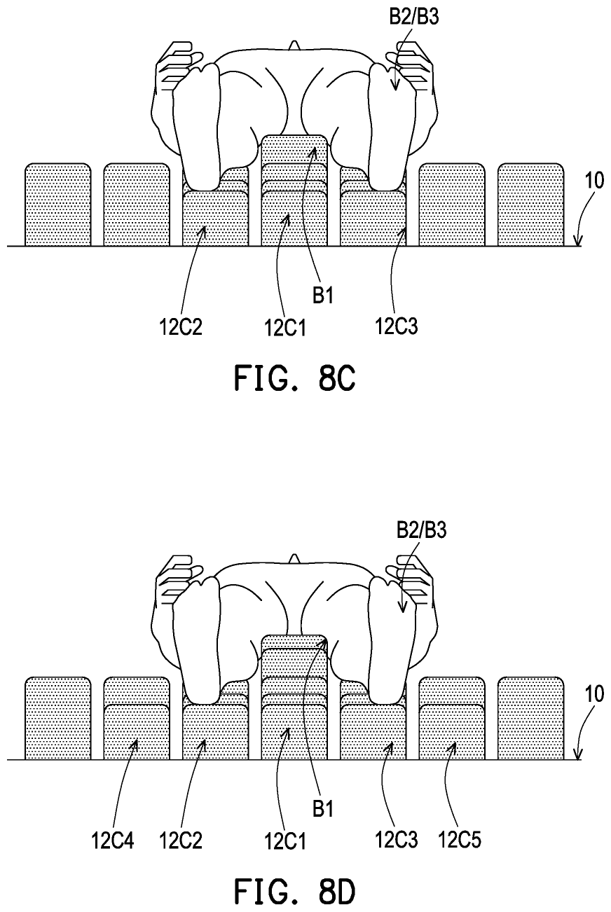

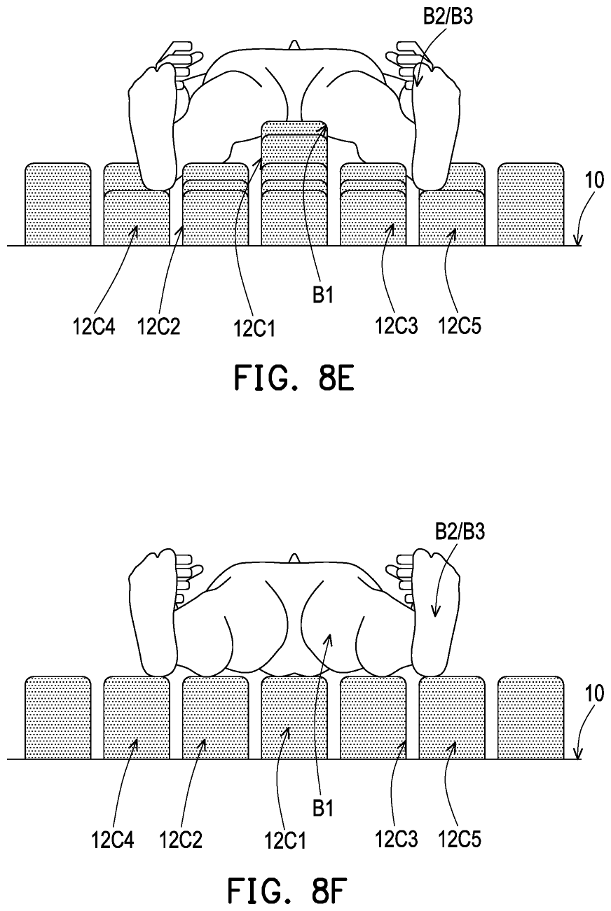

For instance, FIG. 8A to FIG. 8D are schematic views illustrating air pressure adjustment to spread legs apart according to an embodiment of the disclosure. With reference to FIG. 8A, heights of secondary cells 12C1, 12C2, and 12C3 under the human body part B1 (e.g., buttocks) and the human body part B2 (e.g., legs and feet) are the same. With reference to FIG. 8B, next, the air pressure of the secondary cells 12C2 and 12C3 under the human body part B1 is decreased, so that the human body part B2 (e.g., legs) and/or the human body part B3 (e.g., feet) is lowered. With reference to FIG. 8C, next, the air pressure of the secondary cell 12C1 under the middle of the human body part B1 (e.g., intergluteal cleft) is increased. With reference to FIG. 8D, next, the air pressure of the secondary cell 12C1 under the middle of the human body part B1 is kept being increased. In addition, the air pressure of secondary cells 12C4 and 12C5 under the outside of the human body part B2/B3 is decreased.

With reference to FIG. 8E, the inner side of the human body part B2/B3 is pushed outwards by the secondary cell 12C1 and then moves to the secondary cells 12C4 and 12C5. With reference to FIG. 8F, next, the air pressure of the secondary cell 12C1 is decreased and the air pressure of the secondary cells 12C2 to 12C5 is increased, so that the heights of these secondary cells 12C1 to 12C5 are the same. This makes it easier for the caregiver to change diapers or wash along the intergluteal cleft.

It should be noted that according to different design needs and for different target postures, by inflating or deflating some of the secondary cells 12, a specific human body part of the person lying down may be displaced to present the target posture.

In an embodiment, the controller 30 may determine a relative position of the human body part and one or more main cells 11 or a relative position of the human body part and one or more secondary cells 12 according to the air pressure value of the pressure sensor 50. The size and weight of different human body parts may vary, and the area and weight are the factors that affect the pressure. When the human body is lying on the main cells 11 and the secondary cells 12, the controller 30 may compare the air pressure value of the pressure sensor 50 with a comparison table to obtain multiple human body parts whose air pressure corresponds to the weight distribution through formula conversion or machine learning model inference and may identify the main cells 11 and the secondary cells 12 where these human body parts are located.

In an embodiment, based on the main cells 11 and the secondary cells 12 where the human body parts are located, the controller 30 may determine an initial position, a sequence, and a final position of the deflation operation or inflation operation applied on the main cells 11 and/or the secondary cells 12 for each health care item. Taking FIG. 4A and FIG. 4D as an example, the initial position of taking off the pants is the waist and corresponds to the cell group L8, and the final position is the feet and corresponds to the cell group L3. For the sequence of applying the deflation operation or the inflation operation, reference may be made to the abovementioned description of FIGS. 4A to 4D, so the description thereof is not be repeated herein.

In an embodiment, the display 42 may display an arrangement drawing of the main cells 11 and/or the secondary cells 12 of the mattress 10, such as the arrangement shown in FIG. 2A to FIG. 2D. Besides, the controller 30 may further display the main cells 11 and/or the secondary cells 12 and the air pressure value corresponding to each human body part through the display 42. In this way, the caregiver can conveniently control the pressure decrease or pressure increase.

In an embodiment, the image capturing device 60 may photograph the human body to generate a human body image. The controller 30 may determine the relative position of the human body part (of the caregiver or the person lying down) and one or more main cells 11 or the relative position of the human body part and one or more secondary cells 12 according to the human body image. For instance, the controller 30 recognizes human body parts and their positions based on feature comparison or a classifier based on machine learning techniques. In this way, the hand position of the caregiver may be confirmed, and then the progress of the caregiver's action may be known. For instance, when a hand is detected to move away from a specific main cell 11/secondary cell 12, the main cell 11/secondary cell 12 may be inflated. In addition, the posture of the person lying down may be confirmed, for example, whether the legs are spread apart.

In an embodiment, the distance sensor 70 may be disposed beside the main cells 11/the secondary cells 12. The distance sensor 70 may detect the distance to the human body part (of the caregiver or the person lying down). In this way, the hand position of the caregiver may be confirmed, and then the progress of the caregiver's action may be known. For instance, when a hand is detected to move away from a specific main cell 11/secondary cell 12, the main cell 11/secondary cell 12 may be inflated. In addition, the posture of the person lying down may be confirmed, for example, whether the head is lying on the side.

In an embodiment, the controller 30 may determine the initial position and the final position of the deflation operation or inflation operation the corresponding to the health care items applied on the main cells 11 or the secondary cells 12 according to relative position of the human body part (of the caregiver or the person lying down) and one or more main cells 11 or the relative position of the human body part and one or more secondary cells 12. Taking FIG. 4A and FIG. 4D as an example, the hand of the caregiver is located next to the cell group L8, so the initial position for taking off the pants is the cell group L8. Finally, the caregiver's hand stays beside the cell group L3, so the final position of taking off the pants is the cell group L3.

In an embodiment, the input device 41 may be further configured to receive a user instruction. The touch panel receives a click or slide operation, the button receives a press operation, the mouse clicks or moves, the microphone receives a voice command, or the image sensor captures a gesture image. The controller 30 may determine the controlled one or more main cells 11 or the controlled one or more secondary cells 12, a driving sequence or a driving speed, and beginning or ending of the deflation operation or the inflation operation according to the user instruction.

Taking FIG. 4A and FIG. 4D as an example, the hand of the caregiver is located next to the cell group L8, and the caregiver can say an activation voice command (e.g., “waist deflation”), and the air pressure of the cell group L8 begins to be reduced. During the process, the caregiver can say an acceleration voice command (e.g., “speed up”) to increase the speed or switching frequency of the deflation operation or inflation operation. For another example, the caregiver can say a direction voice command (e.g., “go to the head of the mattress”), so that the deflation operation is sequentially applied to the corresponding main cells 11 or secondary cells 12 in a designated direction.

In view of the foregoing, in the air mattress system provided by the embodiments of the disclosure, one or more main cells or secondary cells may be controlled individually or together, and the cells and sequence applied by the deflation operation and/or the inflation operation may be planned for specific health care items. In this way, when the person lying down is lying on the mattress, the caregiver can hold the top or pants and put the top or pants into or out of the human body of the person lying down and can also wash specific human body parts of the person lying down. Besides, the posture of the person lying down may also be changed by adjusting the air pressure of the cells.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An air mattress system, comprising:
a mattress comprising:
a plurality of main cells arranged in parallel between a head end and a tail end of the mattress, wherein at least one of the main cells is configured to allow air pressure therein to be individually adjusted or to be adjusted together with air pressure of other main cells;
a plurality of air pressure valves connected to the main cells and configured to increase air pressure through an inflation operation or decrease air pressure through a deflation operation;
a controller coupled to the air pressure valves and controlling at least one of the air pressure valves to perform the inflation operation or the deflation operation; and
a human machine interface system coupled to the controller, providing a plurality of health care items, and receiving a selective operation of a first target item among the health care items, wherein
the controller controls, according to the first target item, the air pressure valves to sequentially perform one of the deflation operation and the inflation operation on the main cells along a major axis between the head end and the tail end of the mattress.

2. The air mattress system according to claim 1, wherein the main cells comprise a first cell group and a second cell group, the first cell group and the second cell group each comprises at least one main cell, the first cell group is adjacent to the second cell group, the at least one main cell of the first cell group and the at least one main cell of the second cell group are arranged in parallel, and positions of the first cell group and the second cell group on the major axis are different,
regarding the first target item,
the controller performs the deflation operation on the first cell group through the air pressure valves, and
in response to the deflation operation performed on the first cell group, the controller performs the inflation operation on the second cell group through the air pressure valves.

3. The air mattress system according to claim 1, wherein the first target item is to take off pants, and the controller controls the air pressure valves to sequentially perform the deflation operation on the main cells under a buttock, a leg, and a foot of a human body in a direction of the tail end of the mattress, and
in response to a hand moving away from one of the buttock, the leg, and the foot, the controller performs the inflation operation on the main cells under a position where the hand moves away through the air pressure valves.

4. The air mattress system according to claim 1, wherein the first target item is to put on pants, and the controller controls the air pressure valves to sequentially perform the deflation operation on the main cells under a foot, a leg, and a buttock of a human body in a direction of the head end of the mattress, and
in response to a hand moving away from one of the foot, the leg, and the buttock, the controller performs the inflation operation on the main cells under a position where the hand moves away through the air pressure valves.

5. The air mattress system according to claim 1, wherein the first target item is take off a top, and the controller controls the air pressure valves to sequentially perform the deflation operation on the main cells under a buttock or a waist, a back, and a head of a human body in a direction of the head end of the mattress, and
in response to a hand moving away from one of the buttock, the waist, the back, and the head, the controller performs the inflation operation on the main cells under a position where the hand moves away through the air pressure valves.

6. The air mattress system according to claim 1, wherein the first target item is to put on a top, and the controller controls the air pressure valves to sequentially perform the deflation operation on the main cells under a head, a back, and a buttock or a waist of a human body in a direction of the tail end of the mattress, and
in response to a hand moving away from one of the head, the back, the waist, and the buttock, the controller performs the inflation operation on the main cells under a position where the hand moves away through the air pressure valves.

7. The air mattress system according to claim 1, wherein the first target item is to take off clothing, and the controller controls the air pressure valves to sequentially perform the deflation operation on the main cells under a foot, a leg, a buttock, a waist, a back, and a head of a human body in a direction of the tail end of the mattress, and
in response to a hand moving away from one of the foot, the leg, the buttock, the waist, the back, and the head, the controller performs the inflation operation on the main cells under a position where the hand moves away through the air pressure valves.

8. The air mattress system according to claim 1, wherein the first target item is to put on clothing, and the controller controls the air pressure valves to sequentially perform the deflation operation on the main cells under a head, a back, a waist, a buttock, a leg, and a foot of a human body in a direction of the tail end of the mattress, and
in response to a hand moving away from one of the head, the back, the waist, the buttock, the leg, and the foot, the controller performs the inflation operation on the main cells under a position where the hand moves away through the air pressure valves.

9. The air mattress system according to claim 1, wherein the mattress further comprises:
a plurality of secondary cells arranged in parallel along a minor axis between two sides of the mattress and connected to the air pressure valves, wherein at least one of the secondary cells is configured to allow air pressure therein to be individually adjusted or to be adjusted together with air pressure of other secondary cells, and the human machine interface system receives a selective operation of a second target item among the health care items, wherein
the controller controls, according to the second target item, the air pressure valves to perform one of the deflation operation and the inflation operation on the secondary cells.

10. The air mattress system according to claim 9, wherein
regarding the second target item,
the controller performs the deflation operation on part of or all of the secondary cells through the air pressure valves, wherein the second target item is to change a diaper and wipe and wash buttocks or a genital area of a patient.

11. The air mattress system according to claim 10, wherein
in response to the deflation operation performed on the secondary cells under an intergluteal cleft of a human body, the controller performs the inflation operation on the secondary cells under a buttock and between legs of the human body and performs the deflation operation on the secondary cells outside the legs through the air pressure valves.

12. The air mattress system according to claim 1, further comprising:
at least one pressure sensor coupled to the controller, disposed on at least one of the main cells, and is configured to detect an air pressure value, wherein
the controller judges a relative position of a human body part and the main cells according to the air pressure value.

13. The air mattress system according to claim 12, wherein the controller determines an initial position and a final position of the deflation operation or the inflation operation corresponding to the health care items applied on the main cells according to the relative position of the human body part and the main cells.

14. The air mattress system according to claim 1, further comprising:
an image capturing device coupled to the controller and configured to capture a human body image, wherein,
the controller judges a relative position of a human body part and the main cells according to the human body image.

15. The air mattress system according to claim 1, further comprising:
a distance sensor coupled to the controller and configured to detect a distance to a human body part, wherein
the controller judges a relative position of the human body part and the main cells according to the distance between the distance sensor and the human body part.

16. The air mattress system according to claim 1, wherein the human machine interface system comprises:
an input device coupled to the controller and configured to receive a user instruction, wherein
the controller determines the controlled main cell among the main cells, a driving sequence or a driving speed, and beginning or ending of the deflation operation or the inflation operation according to the user instruction.
